(19) United States
(12) Patent Application Publication
(10) Pub. No.: US 2020/0401534 A1
(43) Pub. Date: Dec. 24, 2020

(54) STORAGE CLASS MEMORY WITH IN-MEMORY ONE-TIME PAD SECURITY

(71) Applicant: SanDisk Technologies LLC, Addison, TX (US)

(72) Inventors: Federico Nardi, San Jose, CA (US); Ali Al-Shamma, San Jose, CA (US)

(73) Assignee: SanDisk Technologies LLC, Addison, TX (US)

(21) Appl. No.: 16/450,884

(22) Filed: Jun. 24, 2019

(51) Int. Cl. G06F 12/14; G06F 21/62; G06F 21/78; G06F 7/58

(52) U.S. Cl. CPC G06F 12/1408; G06F 7/588; G06F 21/78; G06F 21/62

(57) ABSTRACT

A memory device includes a memory module that encrypts and decrypts data with a key. To encrypt, the memory module performs a first modified XOR operation in which a ciphertext has a same logical value as a corresponding key when the data has a low logical value and the ciphertext has an inverse of the logical value of the corresponding key when the data is at a high logical value. To decrypt, the memory module performs a second modified XOR operation in which the logical value of the ciphertext forms the logical value of the data when the corresponding key is at the low logical value and the inverse of the logical value of the ciphertext forms the logical value of the corresponding data when the corresponding key is at the high logical value.

### BACKGROUND

Applicant provides the following description to assist the understanding of the reader. None of the information provided or references cited is admitted to be prior art.

Like other kinds of memory, non-volatile memory (NVM) stores data that often requires security to protect the data from unauthorized access or transmission. One means of protecting data stored in non-volatile memory is data encryption. Advancements in memory technologies include storage class memory (SCM) that provides significant speed increases over solid-state drive memory and hard disk drive memory technologies. With the increase in memory speed, there is a need to encrypt data stored in the memory faster. However, current encryption mechanisms are limited in the way those mechanisms are configured and operate.

### SUMMARY

In accordance with some aspects of the present disclosure, a non-transitory computer-readable media having computer-readable instructions stored thereon is disclosed. When the instructions are executed by a processor associated with a memory module, the instructions cause the processor to receive a request to store data in the memory module, generate a true random number key by applying an optimal write pulse to a first plurality of memory cells of the memory module, and perform a first modified XOR operation between the data and the true random number key to obtain a ciphertext. In the first modified XOR operation, a bit of the ciphertext has a same logical value as a corresponding bit of the true random number key when a corresponding bit of the data is at a low logical value and in the first modified XOR operation, the bit of the ciphertext is inverse of the logical value of the corresponding bit of the true random number key when the corresponding bit of the data is at a high logical value.

In accordance with some other aspects of the present disclosure, a non-transitory computer-readable media having computer-readable instructions stored thereon is disclosed. When the instructions are executed by a processor associated with a memory module, the instructions cause the processor to receive a request to store data in the memory module, generate a true random number by applying an optimal write pulse to a first plurality of memory cells of the memory module, generate a pseudo random number key from the true random number, and perform a first modified XOR operation between the data and the pseudo random number key to obtain a ciphertext. In the first modified XOR operation, a bit of the ciphertext has a same logical value as a corresponding bit of the pseudo random number key when a corresponding bit of the data is at a low logical value and in the first modified XOR operation, the bit of the ciphertext is inverse of the logical value of the corresponding bit of the pseudo random number key when the corresponding bit of the data is at a high logical value.

In accordance with yet other aspects of the present disclosure, a memory device is disclosed. The memory device includes a memory controller and a memory module having a key space and a ciphertext space. The memory module encrypts a data with a key that is stored in the key space to obtain a ciphertext that is stored in the ciphertext space. The memory module decrypts the ciphertext with the key to obtain the data and the memory module performs a first modified XOR operation to encrypt the data and a second modified XOR operation to decrypt the ciphertext. In the first modified XOR operation, a bit of the ciphertext has a same logical value as a corresponding bit of the key when a corresponding bit of the data is at a low logical value and the bit of the ciphertext is inverse of the logical value of the corresponding bit of the key when the corresponding bit of the data is at a high logical value and in the second modified XOR operation, the logical value of the bit of the ciphertext forms the logical value of the corresponding bit of the data when the corresponding bit of the key is at the low logical value and the inverse of the logical value of the bit of the ciphertext forms the logical value of the corresponding bit of the data when the corresponding bit of the key is at the high logical value.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of a computing system, in accordance with some embodiments of the present disclosure.

FIG. 2 is an example block diagram showing encryption of a plaintext message for a perfect secrecy or a semantic secrecy implementation, in accordance with some embodiments of the present disclosure.

FIG. 3 is an example block diagram of a memory device showing the perfect secrecy implementation, in accordance with some embodiments of the present disclosure.

FIG. 4 is an example block diagram of a memory device showing the semantic secrecy implementation, in accordance with some embodiments of the present disclosure.

FIG. 5 is a block diagram showing an example comparison between the perfect secrecy implementation of FIG. 3 and the semantic secrecy implementation of FIG. 4, in accordance with some embodiments of the present disclosure.

FIG. 6 is an example block diagram of a peripheral circuit used in the perfect secrecy implementation of FIG. 3 and the semantic secrecy implementation of FIG. 4, in accordance with some embodiments of the present disclosure.

FIG. 7 is an example block diagram of a key generator block for use in the perfect secrecy implementation of the peripheral circuit of FIG. 6, in accordance with some embodiments of the present disclosure.

FIG. 8 is an example block diagram of a key generator block for use in the semantic secrecy implementation of the peripheral circuit of FIG. 6, in accordance with some embodiments of the present disclosure.

FIG. 9A is an example block diagram showing a decryption block of the peripheral circuit of FIG. 6, in accordance with some embodiments of the present disclosure.

FIG. 9B is an example current-voltage characteristic graph showing threshold current detection for performing a modified XOR operation during a decryption operation in the decryption block of FIG. 9A, in accordance with some embodiments of the present disclosure.

FIG. 10A is an example block diagram showing an encryption block of the peripheral circuit of FIG. 6, in accordance with some embodiments of the present disclosure.

FIG. 10B is an example current-voltage characteristic graph showing threshold current detection for performing a modified XOR operation during an encryption operation in the encryption block of FIG. 10A, in accordance with some embodiments of the present disclosure.

FIG. 11 is an example write circuit for use in the decryption block of FIG. 9A and the encryption block of FIG. 10A, in accordance with some embodiments of the present disclosure.

FIG. 12 is an example read circuit for use in the decryption block of FIG. 9A and the encryption block of FIG. 10A, in accordance with some embodiments of the present disclosure.

FIG. 13 is an example flowchart outlining operations for encrypting data using the perfect secrecy implementation, in accordance with some embodiments of the present disclosure.

FIG. 14 is an example flowchart outlining operations for encrypting data using the semantic secrecy implementation, in accordance with some embodiments of the present disclosure.

FIG. 15 is an example flowchart outlining operations for decrypting data using the perfect secrecy and semantic secrecy implementations, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

The present disclosure is directed to a computing system having a memory device. The memory device includes a memory controller communicably coupled to one or more memory modules. Each of the one or more memory modules is configured to encrypt data before storing and decrypt the data when the data is read. Encryption and decryption may be performed using a one-time pad (“OTP”) cipher. The OTP cipher performs an XOR operation between a plaintext message and a key to generate a ciphertext during encryption. During decryption, the OTP cipher performs an XOR operation between the ciphertext and the key that was used to create the ciphertext to obtain the plaintext message. The data that is to be stored into the one or more memory modules constitutes the plaintext message.

Advantages of the OTP cipher include a fast encryption speed and low hardware implementation complexity. The OTP cipher is a perfect secrecy implementation in which the cipher is practically impossible to break and obtain the plaintext message from the ciphertext without knowing the key. In some cases, the perfect secrecy implementation may be implemented in the memory controller. However, with emerging memory technologies such as the storage class memory that have very low program and read latency, the latency of the OTP cipher for encrypting data during program operations and decrypting data during read operations in the memory controller starts becoming a bottleneck. In some cases, a stream or block cipher, which may be easier to implement than the OTP cipher may be used. The stream or block cipher is a semantic secrecy implementation in which the cipher is very hard to break and obtain the plaintext message from the ciphertext without knowing the key. Thus, while stream or block ciphers may not be as robust as OTP ciphers, the stream or block ciphers may be considered suitable for many applications. Thus, depending upon the application, a perfect secrecy or a semantic secrecy implementation may be desired.

The present disclosure provides technical solutions for a flexible mechanism to provide a perfect secrecy implementation and/or a semantic secrecy implementation. The perfect secrecy implementation and a semantic secrecy implementation of the present disclosure are performed in the one or more memory modules (instead of the memory controller), thereby reducing the latency of the encryption and decryption operations. In a perfect secrecy implementation, the system uses a true random number as a key. The present disclosure provides a mechanism to leverage random switching capabilities of certain types of memory technologies to automatically generate true random numbers as part of a write operation. The present disclosure also provides a modified XOR operation based on current-voltage characteristics of the memory module. By using the random switching capabilities of the memory module and the current-voltage characteristics of the memory module, the modified XOR operation may be performed very fast, thereby further reducing the latency of a perfect secrecy implementation.

Similarly, for a semantic secrecy implementation, a pseudo random number key is used. The pseudo random number key is generated from a true random number generated as noted above. The pseudo random number key consumes less space than a true random number key. A similar modified XOR operation may be performed in a semantic secrecy implementation. Thus, based upon the application, a perfect secrecy or a semantic secrecy implementation may be applied at a latency that is less than the latency of conventional perfect secrecy and semantic secrecy implementations.

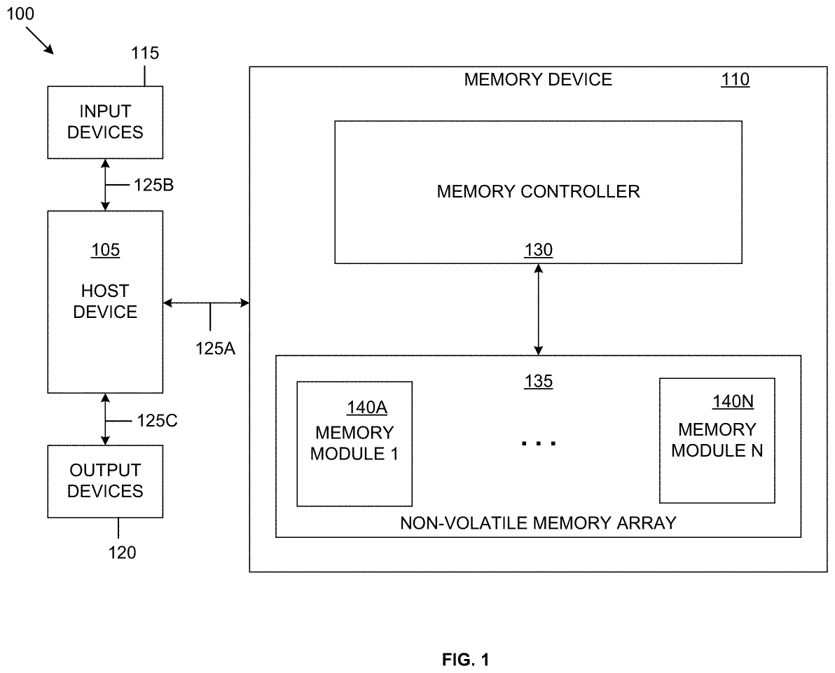

Referring now to FIG. 1, an example block diagram of a computing system 100 is shown, in accordance with some embodiments of the disclosure. The computing system 100 includes a host device 105 associated with a memory device 110. The host device 105 may be configured to receive input from one or more input devices 115 and provide output to one or more output devices 120. The host device 105 may be configured to communicate with the memory device 110, the input devices 115, and the output devices 120 via appropriate interfaces 125A, 125B, and 125C, respectively. The computing system 100 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations using the host device 105.

The input devices 115 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 105 and that allows an external source, such as a user, to enter information (e.g., data) into the host device and send instructions to the host device. Similarly, the output devices 120 may include a variety of output technologies such as external memories, printers, speakers, displays, microphones, light emitting diodes, headphones, plotters, speech generating devices, video devices, global positioning systems, and any other output peripherals that are configured to receive information (e.g., data) from the host device 105. The “data” that is either input into the host device 105 and/or output from the host device may include any of a variety of textual data, graphical data, video data, sound data, position data, combinations thereof, or other types of analog and/or digital data that is suitable for processing using the computing system 100.

Although not shown, the host device 105 may include one or more processing units/processors that may be configured to execute instructions for running one or more applications. In some embodiments, the instructions and data needed to run the one or more applications may be stored within the memory device 110. In such cases, the host device 105 may request the memory device 110 to retrieve the data and instructions, which may then at least temporarily be stored within a memory on the host device. The host device 105 may also be configured to store the results of running the one or more applications within the memory device 110. Thus, the host device 105 may be configured to request the memory device 110 to perform a variety of operations. For example, the host device 105 may request the memory device 110 to read data, write data, update or delete data, and/or perform management or other operations.

The host device 105 may also request the data that is stored within the memory device 110 be encrypted before storing. The host device 105 may request the data to be encrypted using a perfect secrecy implementation or a semantic secrecy implementation, both of which are discussed in greater detail below. Upon receiving the data to be stored, the memory device 110 encrypts the data using either the perfect secrecy implementation or the semantic secrecy implementation (based upon instructions from the host device 105) before storing the data. Similarly, when the encrypted data is to be read, the memory device 110 decrypts the encrypted data and sends the decrypted data to the host device 105.

The memory device 110 includes a memory controller 130 that may be configured to read data from or write data to a non-volatile memory array 135. The non-volatile memory array 135 may include one or more memory modules such as memory modules 140A-140N. Each of the memory modules 140A-140N may include any of a variety of non-volatile memory types. For example, in some embodiments, one or more of the memory modules 140A-140N or portions thereof may include NAND flash memory cores. In other embodiments, one or more of the memory modules 140A-140N or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the non-volatile memory array 135. In some embodiments, one or more of the memory modules 140A-140N or portions thereof may be configured as other types of storage class memory (“SCM”). Further, each of the memory modules 140A-140N may be implemented as a single in-line memory module or a dual in-line memory module.

The memory modules 140A-140N may be individually and independently controlled by the memory controller 130. In other words, the memory controller 130 may be configured to communicate with each of the memory modules 140A-140N individually and independently. The memory modules 140A-140N may remain in a standby state until the memory controller 130 desires to establish communication with one of the memory modules by generating a chip select or chip enable signal. The memory controller 130 may be configured as a logical block or circuitry that receives instructions from the host device 105 and performs operations in accordance with those instructions. For example, the memory controller 130 may be configured to read data from or write data to one or more of the memory modules 140A-140N in response to instructions received from the host device 105. The memory controller 130 may be situated on the same die as the non-volatile memory array 135 or on a different die.

It is to be understood that only some components of the computing system 100 are shown and described in FIG. 1. However, the computing system 100 may include other components such as various batteries and power sources, networking interfaces, routers, switches, external memory systems, controllers, etc. Generally speaking, the computing system 100 may include any of a variety of hardware, software, and/or firmware components that are needed or considered desirable in performing the functions described herein. Similarly, the host device 105, the input devices 115, the output devices 120, and the memory device 110 including the memory controller 130 and the non-volatile memory array 135, may include other hardware, software, and/or firmware components that are considered necessary or desirable in performing the functions described herein.

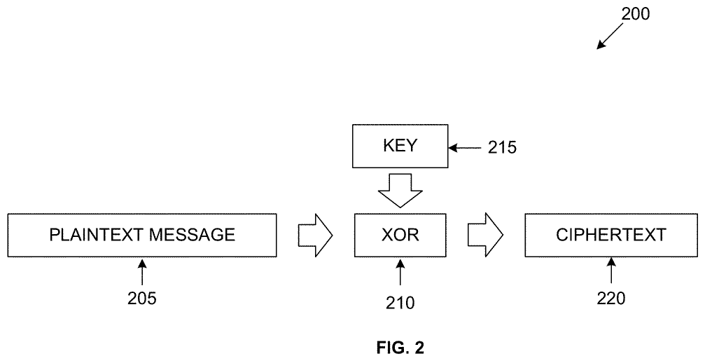

Turning now to FIG. 2, an example block diagram 200 showing encryption of a plaintext message 205 is shown, in accordance with some embodiments of the present disclosure. The encryption using the block diagram 200 may be performed using the perfect secrecy implementation or the semantic secrecy implementation. The plaintext message 205 that is to be encrypted may be data that is sent from the host device (e.g., the host device 105) for storing within the memory device (e.g., the memory device 110). Upon receiving the data (e.g., the plaintext message 205) from the host device (e.g., the host device 105), the memory device (e.g., the memory device 110), and particularly, the memory module (e.g., one of the memory modules 140A-140N) where the data is to be stored may perform the encryption before storing the encrypted data.

Encryption on the plaintext message 205 may be performed by performing a bit-by-bit XOR operation 210 between the plaintext message 205 and a key 215 to obtain a ciphertext 220. The ciphertext 220 is the encrypted data that may be stored within the memory device. The ciphertext 220 may be decrypted using the XOR operation 210 also. Specifically, decryption of the ciphertext 220 may be performed by performing a bit-by-bit XOR operation (e.g., the XOR operation 210) between the ciphertext 220 and the key 215 to obtain the plaintext message 205. The memory module (e.g., one of the memory modules 140A-140N) where the ciphertext 220 is stored may perform the decryption.

An XOR operation may be implemented in accordance with Truth Table 1 below:

Truth Table 1

| INPUT A | INPUT B | OUTPUT |
|---|---|---|
| 0 | 0 | 0 |
| 0 | 1 | 1 |
| 1 | 0 | 1 |
| 1 | 1 | 0 |

Thus, the XOR operation 210 outputs a HIGH logical value during encryption when either a bit of input A (e.g., the plaintext message 205) or a bit of input B (e.g., the key 215) is a HIGH logical value. When both the input A and the input B have HIGH logical values or LOW logical values, the XOR operation 210 outputs a LOW logical value. A HIGH logical value corresponds to a binary value “1” or a designated high voltage level (e.g., 3 volts). Similarly, a LOW logical value corresponds to a binary value “0” or a designated low voltage level (e.g., 0 volt). During decryption, the XOR operation outputs a HIGH logical value when either a bit of input A (e.g., the ciphertext 220) or a bit of input B (e.g., the key 215) is a HIGH logical value. When both the input A and the input B have HIGH logical values or LOW logical values, the XOR operation 210 outputs a LOW logical value. As discussed below, the XOR operation 210 may be performed using a modified XOR implementation in the memory module.

Further, the same XOR operation 210 to encrypt the plaintext message 205 using the key 215 may be performed in both perfect secrecy and semantic secrecy implementations. The key 215 that is used in the perfect secrecy implementation varies from the key that is used in the semantic secrecy implementation. Specifically, in the perfect secrecy implementation, a true random number is used as the key 215. In a semantic secrecy implementation, a pseudo random number is used as the key 215. The key 215 (for the perfect secrecy implementation) may be of the same length or longer than the length of the plaintext message 205. In other words, the key 215 may have the same or greater number of bits than the number of bits in the plaintext message 205. In the semantic secrecy implementation, the key 215 may possibly be shorter in length than the plaintext message 205.

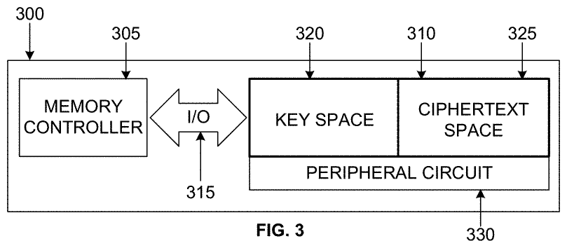

Referring to FIG. 3, an example memory device 300 is shown, in accordance with some embodiments of the present disclosure. The memory device 300 is similar to the memory device 110. Thus, the memory device 300 includes similar elements as the memory device 110, although only some of those elements are shown in the memory device 300. Thus, the memory device 300 includes a memory controller 305 that is in communication with a memory module 310 via a communication bus 315. The memory controller 305 is similar to the memory controller 130 and the memory module 310 is similar to one of the memory modules 140A-140N. Thus, in some embodiments, the memory module 310 may be configured as an SCM memory. Further, the communication bus 315 may be an input/output bus configured to send data to the memory controller 305 for writing within the memory module 310, or for receiving data read from the memory module. Although not shown, the memory controller 305 and the memory module 310 may include other communication buses as well (e.g., to send address, command, chip select signals, etc.). Further, although only the memory module 310 is shown in communication with the memory controller 305, in other embodiments, the memory controller may likewise communicate with other memory modules within the memory device 300. A single memory module (e.g., the memory module 310) is shown within the memory device 300 simply for ease of explanation.

To write data within the memory module 310, the memory controller 305 receives the data from the host device (e.g., the host device 105) and sends that data to the memory module. The memory module 310 encrypts the data before storing. The memory module 310 shows a perfect secrecy implementation. Thus, the memory module 310 includes a key space 320 and a ciphertext space 325. The key space 320 is a dedicated portion of the memory module 310 that is configured for storing one or more keys (e.g., the key 215) that are used for encrypting and decrypting data. The ciphertext space 325 is a dedicated portion of the memory module 310 that is configured for storing ciphertexts (e.g., the ciphertext 220) that are obtained by encrypting data. As indicated above, for perfect secrecy implementations, the key (e.g., the key 215) that is used during encryption and decryption is of the same length or longer than the length of the data (e.g., the plaintext message 205). Thus, the size of the key space 320 may be same as or largely same as the size of the ciphertext space 325. For example, in some embodiments, the size of the key space 320 may be about half of the storage space of the memory module 310 and the ciphertext space 325 may also be about half of the storage space of the memory module.

The memory module 310 also includes a peripheral circuit 330. The peripheral circuit 330 may be integrated within the memory module 310 or be connected to the memory module in operational association. The peripheral circuit 330 is configured to generate true random numbers for use as keys for encrypting data and store the generated keys within the key space 320. In a perfect secrecy implementation, each true random number is used as a key only once (e.g., for one round of encryption and decryption). Thus, when data is to be written to the memory module 310, the peripheral circuit 330 generates a new key (e.g., a new true random number) for the data. To generate the key, the peripheral circuit 330 may receive a signal from the memory controller 305. The signal may be the data itself that is to be written to the memory module 310 and/or an instruction requesting key generation. Upon receiving the signal, the peripheral circuit 330 generates a new key (e.g., the key 215) for encrypting the data. The peripheral circuit 330 stores the generated key within the key space 320, and encrypts the data by performing a modified XOR operation (e.g., the XOR operation 210) between the generated key and the data to generate a ciphertext (e.g., the ciphertext 220). The peripheral circuit 330 then stores the ciphertext in the ciphertext space 325.

Similarly, when data is to be read from the memory module 310, the peripheral circuit 330 may receive a signal from the memory controller 305 to read the data. The signal may include a location (e.g., logical block address or physical block address) of the memory module 310 from where data is to be read. Upon receiving the signal, the peripheral circuit 330 may retrieve the ciphertext corresponding to the data from the physical block address in the ciphertext space 325, retrieve the key that was used to generate that ciphertext from the key space 320, and perform a modified XOR operation between the ciphertext and the key to decrypt the ciphertext and obtain the data. The peripheral circuit 330 then transfers the data to the memory controller 305. Thus, the peripheral circuit 330 may be used to generate keys, encrypt data, and decrypt data.

In some embodiments, a single instance of the peripheral circuit 330 may be used for all memory modules (e.g., the memory module 310 and any other memory modules in the memory device 300), while in other embodiments, an instance of the peripheral circuit may be used for each memory module or a subset of memory modules. Additionally, although the peripheral circuit 330 is described as both generating keys and encrypting/decrypting data, in some embodiments, a separate peripheral circuit may be used for generating keys and another peripheral circuit may be used for encrypting/decrypting data. Thus, the peripheral circuit 330 may be configured in a variety of ways as desired.

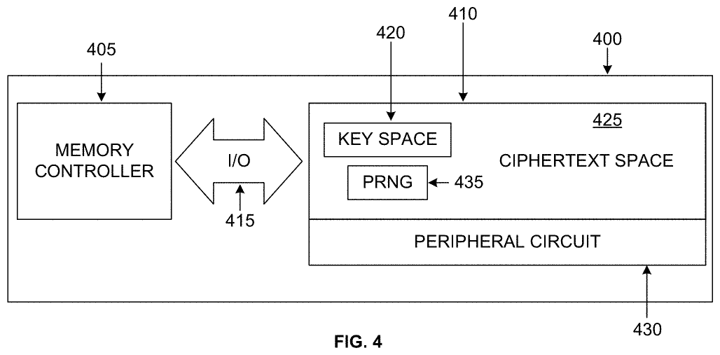

Referring to FIG. 4, an example memory device 400 is shown, in accordance with some embodiments of the present disclosure. The memory device 400 is similar to the memory device 110. Thus, the memory device 400 includes similar elements as the memory device 110, although only some of those elements are shown in the memory device 400. Thus, the memory device 400 includes a memory controller 405 that is in communication with a memory module 410 via a communication bus 415. The memory controller 405 is similar to the memory controller 130 and the memory module 410 is similar to one of the memory modules 140A-140N. Thus, in some embodiments, the memory module 410 may be configured as an SCM memory. Further, the communication bus 415 is similar to the communication bus 315. Further, although only the memory module 410 is shown in communication with the memory controller 405, in other embodiments, the memory controller may likewise communicate with other memory modules within the memory device 400. A single memory module (e.g., the memory module 410) is shown within the memory device 400 simply for ease of explanation.

The memory module 410 is configured for a semantic secrecy implementation. As indicated above, a pseudo random number is used as a key for a semantic secrecy implementation. A pseudo random number is obtained from a true random number, as discussed below. As also discussed below, a pseudo random number may occupy less space than a true random number. Thus, a smaller key space may be used in a semantic secrecy implementation. Thus, as shown in FIG. 4, the memory module 410 includes a key space 420 and a ciphertext space 425 that is larger in size than the key space. The relative sizes of the key space 420 and the ciphertext space 425 may be dependent upon the key size of each key and the number of keys that need to be stored.

The memory module 410 also includes a peripheral circuit 430 and a pseudo random number generator 435. The peripheral circuit 430, similar to the peripheral circuit 330, is configured to generate a true random number from which the pseudo random number generator 435 generates a pseudo random number for use as a key in semantic secrecy implementations. In some embodiments, the pseudo random number generator 435 may also be configured to generate the true random number. The peripheral circuit 430 is also configured to perform a modified XOR operation (e.g., the XOR operation 210) to encrypt and decrypt data. Although shown separate from the peripheral circuit 430, in some embodiments, the pseudo random number generator 435 may be part of the peripheral circuit 430. Further and similar to the peripheral circuit 330, the peripheral circuit 430 may be integrated into the memory module 410 or connected to the memory module in operational association. Similarly, the pseudo random number generator 435 may be integrated into the memory module 410 or connected to the memory module in operational association. Further, a single instance of the peripheral circuit 430 and/or the pseudo random number generator 435 may be used for all of the memory modules (e.g., the memory module 410 and any additional memory modules within the memory device 400) or multiple instances of the peripheral circuit and/or the pseudo random number generator may be used.

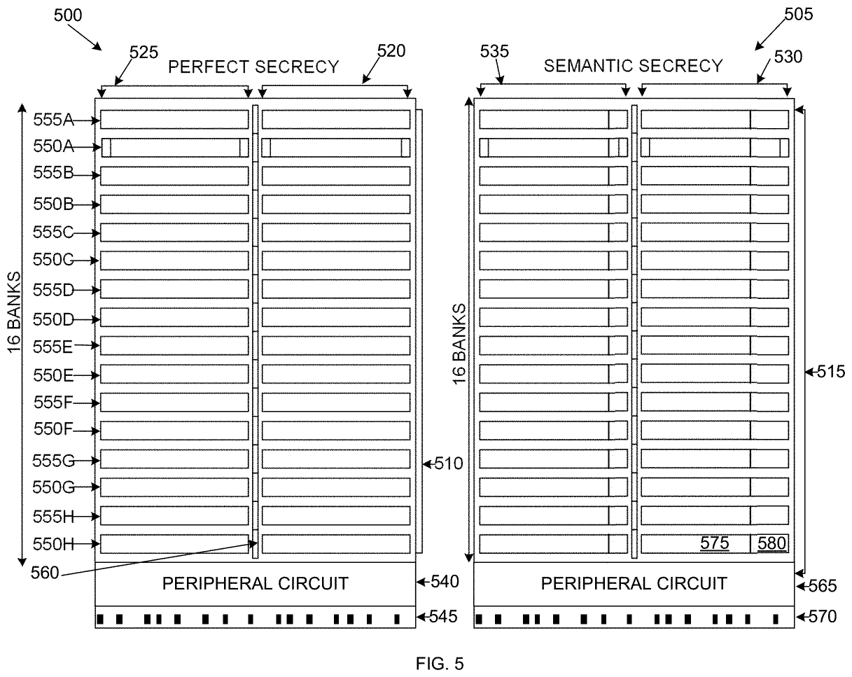

Turning to FIG. 5, a comparison between an example memory module 500 in a perfect secrecy implementation and an example memory module 505 in a semantic secrecy implementation is shown, in accordance with some embodiments of the present disclosure. The memory module 500 is similar to the memory module 310, while the memory module 505 is similar to the memory module 410. For purposes of comparison, the memory module 500 and the memory module 505 both have similar structures. For example, in some embodiments, both the memory module 500 and the memory module 505 are SCM memories having a storage space 510 and 515, respectively, that is divided into sixteen banks configured for independent operation. In other embodiments, the number of banks in each of the storage space 510 and the storage space 515 may vary. Further, in some embodiments, each of the sixteen banks in the storage space 510 and the storage space 515 may be further sub-divided into two sub-arrays. For example, each bank in the storage space 510 may include a sub-array 520 and a sub-array 525, while each bank in the storage space 515 may include a sub-array 530 and a sub-array 535.

In other embodiments, each bank may be divided into greater than two sub-arrays or possibly include no sub-arrays. Further, although not shown in the memory module 500 or the memory module 505, each sub-array of each bank of the storage space 510 and the storage space 515 may be further sub-divided into multiple blocks, such as sixty four blocks, and each block may include multiple tiles, such as four tiles. Each tile may be configured to store one or more words. For example, in some embodiments, each tile may store one hundred and twenty thousand words.

Thus, for example, if the storage space 510 of the memory module 500 is one hundred and twenty eight gigabit in size, each of the sixteen banks may be eight gigabit in size and each of the two sub-arrays (e.g., the sub-array 520, 525) may be four gigabit in size. Further, each of the sixty four blocks of each sub-array may be sixty four megabit in size, and each of the four tiles of each block may be sixteen megabit in size. Additionally, each of the one hundred and twenty thousand words of a tile may be one hundred and twenty eight bits in size. Thus, an operation to read data from or write data to the memory module 500 may be in granularities of one hundred and twenty eight bits. In some embodiments, the storage space 515 of the memory module 505 may be similarly sized. In other embodiments, the various sizes mentioned above may vary.

Further, each bit of a word may be stored within a memory cell (also referred to herein as memory element). In some embodiments, a memory cell may be configured as a single level memory cell to store a single bit of information in the memory cell. In other embodiments, a memory cell may be configured as a multi-level memory cell to store multiple bits of information in the memory cell. Thus, the number of bits of a word that may be stored within a memory cell may be determined based upon whether the memory cell is configured as a single level memory cell or a multi-level memory cell. Additionally, in some embodiments, each bank may include a different number of sub-arrays, each sub-array may include a different number of blocks, each block may include a different number of tiles, and each tile may store a different number of words than what is described above.

The memory module 500 may also include a peripheral circuit 540 configured to generate true random number keys for a perfect secrecy implementation, and for encrypting/decrypting data using the true random number keys to generate ciphertexts. The peripheral circuit 540, which is similar to the peripheral circuit 330, may be configured to store the generated keys and ciphertexts in one or more banks of the storage space 510. The memory module 500 may also include memory pads 545 that enable the memory module to communicate with an associated memory controller. Further, as discussed above, for a perfect secrecy implementation, since the key (e.g., the true random number) is same or longer in length than the plaintext message (e.g., the data) and since each piece of data has a separate key, same or similar amount of space is needed to store the key and the plaintext message. Thus, as shown in the memory module 500 having the sixteen banks in the storage space 510, eight banks 550A-550H may be used for storing keys and eight banks 555A-555H may be used for storing ciphertexts. Thus, for example, for one hundred and twenty thousand words in each tile, one hundred and twenty thousand keys may be stored. The eight banks 550A-550H that store the keys form the key space (e.g., the key space 320) of the memory module 500 and the eight banks 555A-555H that store the ciphertext form the ciphertext space (e.g., the ciphertext space 325) of the memory module.

It is to be understood that although the eight banks 550A-550H that store the keys and the eight banks 555A-555H that store the ciphertext are shown interleaved with one another, in some embodiments, the banks that store the keys and the banks that store the ciphertext need not be interleaved. Rather, the keys and the ciphertexts may be stored in any banks so long as the location of the keys and ciphertext is known to the peripheral circuit 540. Further, although the memory module 500 is shown with each bank storing either a key or a ciphertext, in some embodiments, each bank may store both keys and ciphertext so long as same or substantially similar space is allocated to keys and ciphertexts.

Further, in addition to the peripheral circuit 540, each of the sixteen banks in the storage space 510 may include an individual state machine or circuit 560 to perform operations in the associated bank. Similarly, although not shown, each sub-array, block, tile, and/or word may have individual state machine or circuit associated therewith for performing operations.

Similar to the memory module 500, the memory module 505 includes a peripheral circuit 565 and memory pads 570. The peripheral circuit 565, which is similar to the combination of the peripheral circuit 430 and the pseudo number generator 435, is configured to generate pseudo random numbers for a semantic secrecy implementation. The pseudo random numbers may be generated from reduced sized true random numbers, and thus do not require as much storage space as true random numbers. Further, one reduced size true random number may be used to generate multiple pseudo random numbers, further reducing the amount of space needed to store the pseudo random numbers. Thus, in contrast to the perfect secrecy implementation in which the keys occupy entire banks, in a semantic secrecy implementation, the keys occupy only a portion of a bank. For example, as shown in the storage space 515, each of the sixteen banks is configured to store ciphertexts in a ciphertext space 575 (only one of which is marked in FIG. 5) obtained by the semantic secrecy implementation and a portion 580 (only one of which is marked in FIG. 5) of each of those banks is reserved for storing keys used to obtain those ciphertexts. Thus, each bank in the storage space 515 includes both a ciphertext space (e.g., the ciphertext space 325) and a key space (e.g., the key space 320).

In some embodiments, instead of reserving a portion of each bank in the storage space 515 for the keys, certain banks may be used to store only the keys similar to the perfect secrecy implementation. However, the number of banks that may be needed to store the keys may be significantly lower than the number of banks needed in the perfect secrecy implementation. The amount of space in the storage space 515 that may be needed to store the pseudo random numbers keys in a semantic secrecy implementation may depend upon how many pseudo random number keys are generated from one true random number. For example, in some embodiments, the relative size of the storage space used for the ciphertext space and for the key space may vary according to Table 2 below:

TABLE 2

| | Key Space (Number of |
|---|---|
| | pseudo random number |
| Ciphertext | keys generated from one |
| Space | true random number) |
| ~128 Gb | ~1 Mb |
| | (1 key per Tile) |
| ~128 Gb | ~260 kb |
| | (1 key per Block) |
| ~128 Gb | ~4.1 kb |
| | (1 key per Sub-Array) |
| ~128 Gb | ~2 kb |
| | (1 key per Bank) |
| ~128 Gb | 128 b |
| | (1 key per Die) |

Table 2 above shows a storage size for a ciphertext space in the first column and a corresponding storage size of the key space in the second column in a semantic secrecy implementation. The second column of Table 2 also shows the number of pseudo random keys that may be generated from one true random number. For example, row 1 of Table 2 above shows that when one true random number is used to generate pseudo random keys for one tile (e.g., one hundred and twenty thousand words), then the total key space for the memory module 505 may be about one megabits and the total ciphertext space may be about one hundred and twenty eight gigabits. Similarly, when one true random number is used to generate pseudo random keys for one entire block (e.g., four tiles), then the total key space for the memory module 505 may be about two hundred and sixty kilobits and the total ciphertext space may be about one hundred and twenty eight gigabits, and so on.

Thus, in a semantic secrecy implementation, instead of consuming about half the total storage space of a memory module, the key space constitutes a fraction of the total storage space of the memory module.

Further, while the true random number is only used once (e.g., one round of encryption and one round of decryption of corresponding data) as a key when used in a perfect secrecy implementation, one true random number may be used to generate multiple pseudo random numbers in a semantic secrecy implementation.

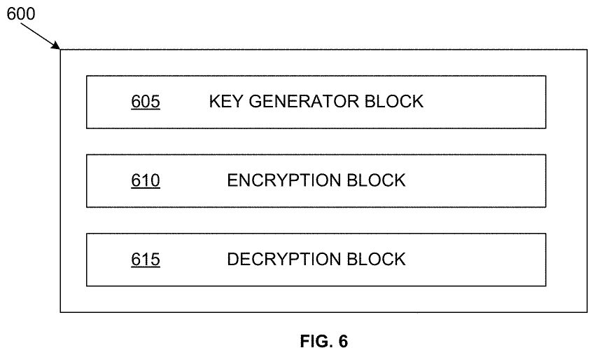

Turning now to FIG. 6, an example block diagram of a peripheral circuit 600 is shown, in accordance with some embodiments of the present disclosure. The peripheral circuit 600 is similar to the peripheral circuit 540 and the peripheral circuit 565 of FIG. 5. The peripheral circuit 600 may be used to generate keys such as a true random number key for a perfect secrecy implementation and a pseudo random number key for a semantic secrecy implementation. The peripheral circuit 600 may also be used to perform an encryption operation (also referred to herein as a write XOR mode operation) to obtain a ciphertext from a plaintext message (e.g., data), and a perform a decryption operation (also referred to herein as a read XOR mode operation) to obtain the plaintext message from the ciphertext. The peripheral circuit 600 may generate keys (true random number keys and pseudo random number keys) and perform encryption/decryption operations using read and write operations on the associated memory module. In some embodiments, the peripheral circuit 600 may perform a read operation via a read circuit and perform a write operation via a write circuit.

Thus, the peripheral circuit 600 may include a key generator block 605, an encryption block 610, and a decryption block 615. Although only the key generator block 605, the encryption block 610, and the decryption block 615 are shown in the peripheral circuit 600, in other embodiments, the peripheral circuit may include other or additional components that may be needed or considered desirable to have in performing the operations described herein. The key generator block 605 may be used to generate true random number keys when used in a perfect secrecy implementation. In a semantic secrecy implementation, the key generator block 605 may be configured to generate true random numbers, as well as generate pseudo random numbers from the true random numbers. The key generator block 605 may be implemented in hardware, software, firmware, or a combination thereof. Although not shown, the peripheral circuit 600 may include one or more processors, memory units, and other elements that enable the peripheral circuit to perform the functions described herein.

The encryption block 610 is configured to generate a ciphertext from a plaintext message (e.g., data). Thus, the encryption block 610 is configured to receive the plaintext message from the associated memory controller (or the associated host device or another associated component), perform a read operation (e.g., using a read circuit) to read the key generated by the key generator block 605, and perform a write operation (e.g., using a write circuit) to write a result (e.g., ciphertext) of a bit-by-bit modified XOR operation between the plaintext message and the key. Thus, the encryption block 610 uses both read and write operations for performing an encryption operation. The encryption block 610 may be implemented in hardware, software, firmware, or combination thereof. Similarly, the decryption block 615 is configured to perform a first read operation (e.g., using a read circuit) to read a ciphertext that is to be decrypted from the ciphertext space, perform a second read operation (e.g., using the read circuit) to read the key from which the ciphertext was generated from the key space, and perform a bit-by-bit modified XOR operation to output the decrypted ciphertext. Like the encryption block 610, the decryption block 615 may be implemented in hardware, software, firmware, or combination thereof.

Further, although the key generator block 605, the encryption block 610, and the decryption block 615 are shown as separate components in the peripheral circuit 600, in some embodiments, at least some of those elements may be integrated together into a single element and the single element may perform the operations of the individual elements.

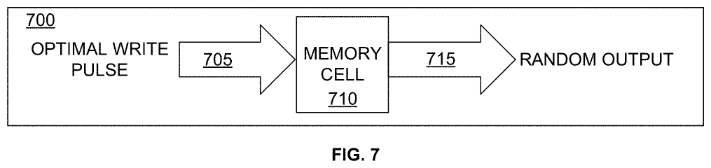

Referring to FIG. 7, an example block diagram of a key generator block 700 of a peripheral circuit used in a perfect secrecy implementation is shown, in accordance with some embodiments of the present disclosure. The key generator block 700 is similar to the key generator block 605 for a perfect secrecy implementation. Thus, the key generator block 700 is configured to generate true random numbers for use as keys in a perfect secrecy implementation. The key generator block 700 is configured to generate true random numbers by applying a current (Iprog) via the write circuit to a memory cell of the associated memory module to program the memory cell.

Specifically, certain emerging non-volatile memory technologies offer new physical phenomenon that may be used as a source of entropy, which may be used to generate true random numbers. For example, the switching mechanism of a PCM memory cell may be used to create true random numbers. By applying write pulses of certain magnitude, width, and amplitude (referred to herein as an optimal write pulse), a switching probability of about fifty percent may be induced such that about half the bits of the memory cells to which such write pulses are applied switch and program to a HIGH logical level (e.g., “1”) and about half of the memory cells switch and program to a LOW logical level (e.g., “0”). Since the bits that switch and program to the HIGH logical level and the bits that switch and program to the LOW logical level are random with no apparent pattern, this inherent randomness of the memory cells create a true random number when optimal write pulses are applied.

Similarly, a spin transfer torque MRAM (STT_MRAM) memory cell may be used to create a true random number. Similar to a PCM memory cell, an STT-MRAM memory cell is prone to random switching when a write pulse of a certain magnitude, width, and amplitude (referred to herein as an optimal write pulse) is applied. Specifically, applying an optimal write pulse induces thermal fluctuations within the memory cell, which in turn induces a random switching probability within the memory cell such that about half the bits of the memory cells to which such write pulses are applied switch and program to a HIGH logical level (e.g., “1”) and about half of the memory cells switch and program to a LOW logical level (e.g., “0”). Thus, physical properties (e.g., random switching on application of optimal write pulses) of certain types of memory cells may be exploited to generate true random numbers.

Therefore, as shown in FIG. 7, the key generator block 700 is configured to apply an optimal write pulse 705 to a memory cell 710. The optimal write pulse is a current pulse of a designated magnitude, width, and amplitude based on the type of the memory cell 710 (e.g., PCM, STT-MRAM, etc.). In some embodiments, the optimal write pulse 705 may be a current pulse of about fifty percent width and/or amplitude and of a magnitude that is sufficient to program the memory cell 710. In other embodiments, the optimal write pulse 705 may be of other widths/amplitudes. The magnitude, width, and amplitude of the optimal write pulse may be programmed within the key generator block 700. Upon receiving the optimal write pulse 705, the memory cell 710 may randomly switch. For a single level cell configured to store a single bit of information, the memory cell 710 may randomly switch between a HIGH and LOW logical level. For a multi-level memory cell configured to store multiple bits of information, each of the bits may randomly switch between HIGH and LOW logic levels.

Further, depending upon whether the memory cell 710 is configured as a single level memory cell or a multi-level memory cell, the optimal write pulse 705 may be applied to multiple memory cells depending upon the length of the true random number that is desired. As discussed above, the length of the true random number key that is used in a perfect secrecy implementation may be same as or longer than the length of the plaintext message that is to be encrypted. Thus, for example, for a one hundred and twenty eight bit plaintext message, at least a one hundred and twenty eight bit true random number key may be used, and depending upon the number of bits each memory cell is configured to store, multiple memory cells may need to be programmed to generate the at least one hundred and twenty eight bit true random number. Therefore, although the optimal write pulse 705 is shown as being applied to a single one of the memory cell 710, in other embodiments, the optimal write pulse may also be applied to other memory cells. Further, in some embodiments, the same optimal write pulse 705 may be applied to each of the memory cell 710 to which the optimal write pulse is applied. In other words, the magnitude, width, and amplitude of the write pulse that is applied to each of the memory cell 710 may be the same. In other embodiments, one or more of the magnitude, pulse, and amplitude of the write pulse may vary from one memory cell to another memory cell.

Upon applying the optimal write pulse 705 to the memory cell 710, the memory cell is programmed based upon the random switching property of the memory cell and the programmed state of the memory cell is the random output 715. When the memory cell 710 is configured as a single level memory cell, the output 715 is a single bit of the true random number. When the memory cell 710 is configured as a multi-level memory cell, the output 715 is multiple bits of the true random number. The output 715 of all of the memory cells 710 to which the optimal write pulse 705 is applied together constitutes the entire true random number. Thus, one or more memory cells may be programmed using one or more optimal write pulses taking advantage of those memory cells' random switching properties to generate a true random number.

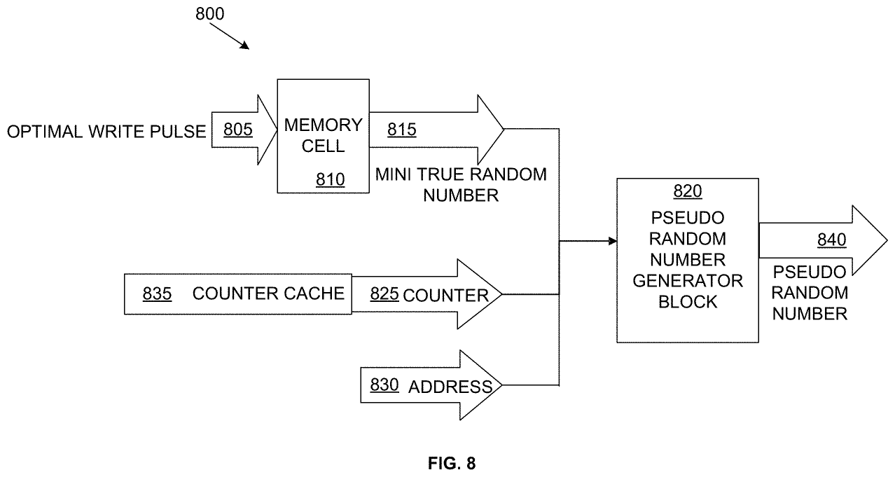

Turning now to FIG. 8, an example block diagram of a key generator block 800 of a peripheral circuit used in a semantic secrecy implementation is shown, in accordance with some embodiments of the present disclosure. The key generator block 800 is similar to the key generator block 605 for a semantic secrecy implementation. Thus, the key generator block 800 is configured to generate pseudo random numbers for use as keys in a semantic secrecy implementation. The key generator block 800 is configured to generate pseudo random numbers by first generating a true random number and then using the true random number to generate multiple pseudo random numbers.

Thus, as shown in FIG. 8, an optimal write pulse 805 is applied to a memory cell 810 to generate a true random number output 815. The optimal write pulse 805 is a current pulse and similar to the optimal write pulse 705. When the optimal write pulse 805 is applied, the memory cell 810 randomly switches to generate one or more bits of a true random number (e.g., the output 815). Although a single one of the memory cell 810 is shown, similar to FIG. 7, the optimal write pulse 805 may be applied to multiple memory cells depending upon the length of the true random number that is desired and the number of bits that each memory cell is configured to store. Further, the true random number that is used for generating pseudo random numbers may be of a shorter length compared to the true random number that is used for a perfect secrecy implementation. Thus, in some embodiments, the optimal write pulse 805 may be applied to a fewer number of memory cells to obtain a reduced length true random number. The desired reduced length of the true random number used for generating the pseudo random numbers may be pre-determined and programmed within the key generator block 800. By virtue of using a shorter length true random number for generating pseudo random numbers, the amount of space that is needed to store the true random number in a semantic secrecy implementation is reduced.

In other embodiments, the true random number that is generated from the optimal write pulse 805 may be of the same length as the true random number that is generated from the optimal write pulse 705. In such cases, the length may be reduced using other mechanisms. For example, in some embodiments, the full length true random number may be cropped or logical operations may be applied on the bits to reduce the length of the full length true random number.

Thus, the output 815 is a reduced length true random number (also referred to herein as a mini true random number). The output 815 may be used as a seed or input to a pseudo random number generator block 820. In addition to the output 815, a value of a counter 825, and an address 830 may be input into the pseudo random number generator block 820. The value of the counter 825 is indicative of a number of times a word at a particular physical address location has been encrypted or written into the associated memory cell. Specifically, in some embodiments, the memory module (e.g., the memory modules 410) may be configured to encrypt or decrypt one hundred and twenty bits or sixteen bytes (which make up one word) in parallel. The “word” is the fundamental unit that the host device (e.g., the host device 105) deals with by referring to the word's logical block address when reading or writing data from the memory module. For each logical block address, there is a corresponding physical block address. The translation from the logical block address to the physical block address is performed by the memory controller (e.g., the memory controller 405). A counter cache 835 may be implemented in the peripheral circuit (e.g., the peripheral circuit 430) of the memory module and/or the memory controller to keep track of how many times a specific physical block address of a word has been written (e.g., how many times a word has been encrypted in that specific physical block address location). Thus, each time word is encrypted and written to a particular physical address location, the counter 825 may be incremented and the incremented value may be stored in the counter cache 835. The value of the counter 825 may also be used as an input for the pseudo random number generator block 820. The length of the value of the counter 825 may be pre-determined. The address 830 is the address (e.g., the physical block address) of the memory module where the plaintext message being encrypted is to be stored.

Thus, the output 815, the value of the counter 825, and, the address 830 are input into the pseudo random number generator block 820. The pseudo random number generator block 820 may be configured as software, hardware, firmware, or combination thereof, and may be used to generate pseudo random numbers from the output 815, the value of the counter 825, and the address 830. In some embodiments, the pseudo random number generator block 820 may concatenate the output 815, the value of the counter 825, and the address 830. In other embodiments, the pseudo random number generator block 820 may apply a logical operation (e.g., XOR operation) on the output 815, the value of the counter 825, and the address 830. In yet other embodiments, the pseudo random number generator block 820 may both concatenate and apply a logical operation on the output 815, the value of the counter 825, and the address 830. The result of the pseudo random number generator block 820 is a pseudo random number 840.

By varying the value of the counter 825 and/or the address 830, multiple pseudo random numbers may be generated from one true random number (e.g., the output 815). The pseudo random number 840 may be used as a key for a semantic secrecy implementation.

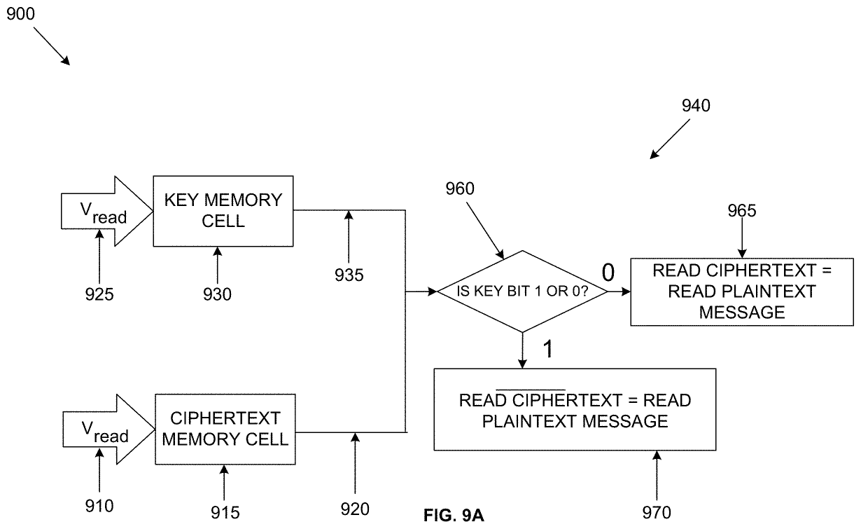

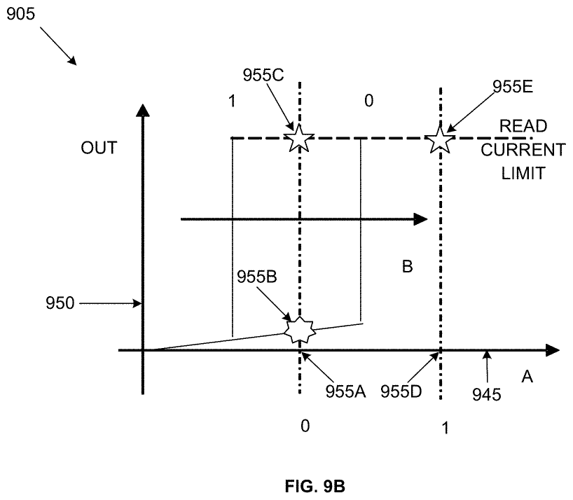

Referring to FIGS. 9A and 9B, a decryption operation performed by a peripheral circuit (e.g., the peripheral circuit 600) is shown, in accordance with some embodiments of the present disclosure. Thus, FIG. 9A shows an example decryption block 900, in accordance with some embodiments of the present disclosure. FIG. 9B shows an example current-voltage characteristic 905 of a memory cell associated with the decryption block 900. The decryption block 900 is similar to the decryption block 615. As discussed above, decryption is applied on a ciphertext to obtain a plaintext message. Specifically, a bit-by-bit modified XOR operation is performed between the bits of the ciphertext and the key that was used to encrypt the plaintext message to obtain the plaintext message from the ciphertext. The decryption operation of the decryption block 900 may be used for both the perfect secrecy implementation and the semantic secrecy implementation. However, the keys that are used in the decryption block 900 vary based upon whether the decryption block is implemented in a perfect secrecy implementation or a semantic secrecy implementation. Thus, a true random number key is used in the decryption block 900 for a perfect secrecy implementation and a pseudo random number key is used in the decryption block for a semantic secrecy implementation.

In some embodiments, the modified XOR operation may be performed by using a transistor logic (e.g., CMOS or pass transistor) in the decryption block 900. In other embodiments, the modified XOR operation may be performed using current threshold detection based upon the current-voltage characteristic 905 of the memory cell. The decryption block 900 may perform the decryption operation in response to a request to read data stored within memory cells of a memory module. Thus, upon receiving a read request, the decryption block 900 (or another component) may first determine the address of where the ciphertext corresponding to the data is stored within the memory module. Upon identifying the address, the decryption block 900 reads the bit(s) from each of the memory cells that store the ciphertext. The decryption block 900 may read the data using a read circuit. Thus, as shown in FIG. 900, the decryption block 900 applies a voltage pulse 910 to a memory cell 915 to read one or more bits, and the read bits are output as ciphertext 920. Although a single one of the memory cell 915 is shown in the decryption block 900, the voltage pulse 910 is applied to each of the memory cells in which the bits of the ciphertext to be read are stored. The attributes (e.g., magnitude, width, amplitude, etc.) of the voltage pulse 910 that is applied to the memory cell 915 may be known to the decryption block 900. The decryption block 900 may include a voltage pulse generator or other component to generate the voltage pulse 910.

In addition to reading the ciphertext 920, the decryption block 900 reads the key that was used to create that ciphertext. Thus, similar to reading the ciphertext, the decryption block 900 applies a voltage pulse 925 to a memory cell 930 that stores one or more bits of the key, and generates a key output 935. Upon reading all the bits of the key and all the bits of the ciphertext, the decryption block 900 performs a bit-by-bit modified XOR operation 940. In some embodiments, the decryption block 900 performs the modified XOR operation 940 based upon current threshold detection using the current-voltage characteristic 905 of the memory cell 915 and the memory cell 930.

Thus, referring to the current-voltage characteristic 905 of FIG. 9B in conjunction with the decryption block 900 of FIG. 9A, the overall current-voltage characteristic of the memory cell 915 and the memory cell 930 is shown, in accordance with some embodiments of the present disclosure. The current-voltage characteristic 905 shows voltage of the memory cell 930 (e.g., of the memory cell storing the key) on X-axis 945 and total read current (e.g., total read current from the memory cell 915 plus from the memory cell 930) on Y-axis 950. When a voltage pulse to read a LOW logical value 955A (e.g., “0”) is applied to the memory cell 930 storing the key, the total read current depends upon the logical value of the memory cell 915 storing the ciphertext. For example, when a voltage pulse to read a LOW logical value (“0”) of the memory cell 915 is applied, a LOW total read current value 955B is detected at the output. The LOW total read current value 955B corresponds to a LOW logical value. Similarly, when a voltage pulse to read a HIGH logical value (“1”) is applied to the memory cell 915, a HIGH total read current value 955C is detected at the output. The HIGH total read current value 955C corresponds to a HIGH logical value. In other words, when the key (e.g., the memory cell 930) is at a LOW logic value, the total read current depends upon the logical value of the ciphertext (e.g., the memory cell 915) in accordance with Truth Table 2 below:

Truth Table 2

| Key | Ciphertext | Output |
|---|---|---|
| 0 | 0 | 0 |
| 0 | 1 | 1 |

Thus, the values in Truth Table 2 are same as that of the first two rows of Truth Table 1 above. Further, the output in Truth Table 2 is same as the value of the ciphertext.

However, when a voltage pulse to read a HIGH logical value 955D is applied to the memory cell 930 to read one or more bits of the key, a total read current value 955E is read regardless of the logical value of the memory cell 915. In other words, regardless of whether the voltage pulse to read a HIGH or LOW logical value is applied to the memory cell 915, the total read current value 950E, which corresponds to a HIGH logical value, is read. In other words, when the key (e.g., the memory cell 930) is at a HIGH logical value, the total read current varies in accordance with Truth Table 3 below:

Truth Table 3

| Key | Ciphertext | Output |
|---|---|---|
| 1 | 0 | 1 |
| 1 | 1 | 1 |

The output values in the Truth Table 2 are inverse of rows 3 and 4 output values in Truth Table 1 above. Thus, when the key (e.g., the memory cell 930) is at a HIGH logical value, the output in Truth Table 3 above is modified using an inverse read operation using one or more inverters and the following logic:
Modified XOR Output=NOT (XOR Output (NOT (Key), Ciphertext))

Applying the logic above, Truth Table 3 is modified in Truth Table 4 as follows:

Truth Table 4

| | | | | Modified |
|---|---|---|---|---|
| | NOT | | XOR | XOR |
| Key | (Key) | Ciphertext | Output | Output |
| 1 | 0 | 0 | 0 | 1 |
| 1 | 0 | 1 | 1 | 0 |

Thus, by inverting the key, a LOW logical value is obtained for the key, and the total read current values 955B and 955C are obtained based on the logical values of the ciphertext in accordance with Truth Table 2. These values are shown in the “XOR output” column of Truth Table 4 above. Further, by inverting the “XOR output” values, the “modified XOR output” values of column 5 in Truth Table 4 above are obtained, which correspond to the correct output values in an XOR operation in accordance with Truth Table 1. Thus, when the key (e.g., the memory cell 930) is at a HIGH logical level, a modified read operation is performed by inverting the logical level of the key, using the total read current values 955B and 955C, and again inverting the total read current values to obtain the modified output values. As also shown in Truth Table 4 above, the modified output values are inverse of the ciphertext values.

Returning to FIG. 9A, thus, the modified XOR operation 940 may be performed by first determining whether the key bit is at a HIGH or a LOW logical value. The modified XOR operation 940 may be applied for each bit of the key (e.g., the key output 935) and each bit of the ciphertext (e.g., the ciphertext 920). Thus, upon determining in a logic block 960 that the key is at a LOW logical value, the value of the ciphertext is read as the value of the plaintext message, as shown in logic block 965. Thus, if the ciphertext bit is at a LOW logical value, the corresponding bit of the plaintext message (e.g., output in Truth Table 2) is at a LOW logical value and if the ciphertext bit is at a HIGH logical value, the corresponding bit of the plaintext message (e.g., the output in Truth Table 2) is also at HIGH logical value. In contrast, if the key bit, as determined in the logic block 960, is at a HIGH logical value, an inverted value of the ciphertext bit is read as the value of the corresponding plaintext bit, as shown in logic block 970. Thus, if the ciphertext is at a LOW logical value, the corresponding bit of the plaintext message (e.g., the modified output in Truth Table 4) is at a HIGH logical value and if the ciphertext bit is at a HIGH logical value, the corresponding bit of the plaintext message is at a LOW logical value.

Thus, by current threshold detection, the decryption block 900 performs a bit-by-bit modified XOR operation to decrypt the ciphertext using the key.

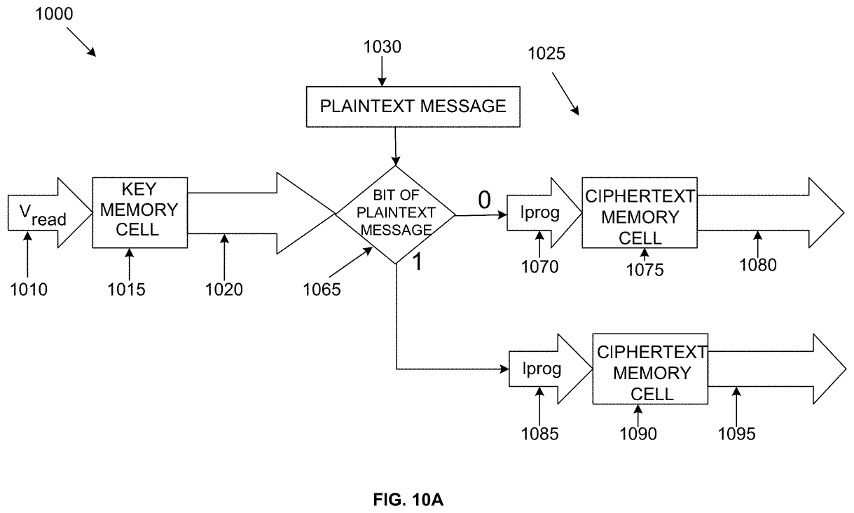

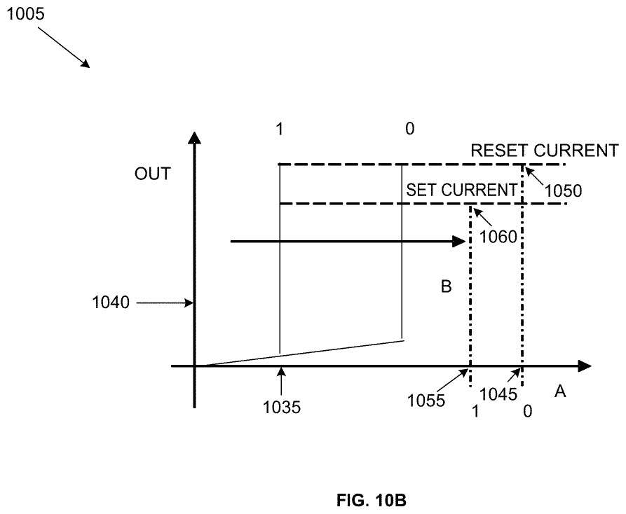

Referring to FIGS. 10A and 10B, an encryption operation performed by a peripheral circuit (e.g., the peripheral circuit 600) is shown, in accordance with some embodiments of the present disclosure. Thus, FIG. 10A shows an example encryption block 1000, in accordance with some embodiments of the present disclosure. FIG. 10B shows an example current-voltage characteristic 1005 of memory cells associated with the encryption block 1000. The encryption block 1000 is similar to the encryption block 610. As discussed above, encryption is applied on a plaintext message to obtain a ciphertext. Specifically, a bit-by-bit modified XOR operation is performed between the bits of the plaintext message and the bits of a key to obtain the ciphertext from the plaintext message. The encryption operation of the encryption block 1000 may be used for both the perfect secrecy implementation and the semantic secrecy implementation. However, the keys that are used in the encryption block 1000 vary based upon whether the encryption block is implemented in a perfect secrecy implementation or a semantic secrecy implementation. Thus, a true random number key is used in the encryption block 1000 for a perfect secrecy implementation and a pseudo random number key is used in the encryption block for a semantic secrecy implementation.

The encryption block 1000 may perform an encryption operation when a data or plaintext message is to be written to a memory module associated with the encryption block. Before encrypting the plaintext message, the key generator block (e.g., the key generator block 605) generates a key to be used during encryption. In a perfect secrecy implementation, each key is only used once (e.g., for one round of encryption/decryption). Thus, even if a previously stored ciphertext is decrypted, updated, and written back as an updated plaintext message, a new key is used for encrypting the updated plaintext message. Thus, before a plaintext message is encrypted, the associated key generator block generates a new true random number key for use during encryption in a perfect secrecy implementation. In a semantic secrecy implementation, a new pseudo random number key may be generated for encryption each time a plaintext message is encrypted. The key generator block may store the key in one or more memory cells, as discussed above. The encryption block 1000 reads the stored key from the associated memory module for encrypting the plaintext message.

Thus, as shown in FIG. 10A, the encryption block 1000, via the read circuit, applies a voltage pulse 1010 to read the key stored in a memory cell 1015. Although a single one of the memory cell 1015 is shown, as discussed above, the key may be stored in multiple memory cells and the voltage pulse 1010 may be applied to each of the memory cells in which the key is stored to obtain key output 1020. Upon reading the key output 1020, the encryption block 1000 performs a bit-by-bit modified XOR operation 1025 between the bits of the key output and the bits of a plaintext message 1030. The modified XOR operation 1025 for encryption may also be performed using a current threshold detection in some embodiments, while in other embodiments, a CMOS or pass transistor logic may be implemented in the encryption block 1000 for performing the modified XOR operation.

The modified XOR operation 1025 via current threshold detection may be performed in accordance with the current-voltage characteristic 1005 of FIG. 10B. Referring to FIG. 10B in conjunction with 10A, an X-axis 1035 of the current-voltage characteristic 1005 shows a magnitude of the voltage pulse needed to read a particular bit of the plaintext message 1030, and Y-axis 1040 shows a magnitude of total read current detected due to reading a bit of the key (e.g., from the memory cell 1015) and reading a bit of the plaintext message 1030. When a voltage pulse 1045 is applied to read a LOW logical value of the plaintext message 1030, a total read current value 1050, which is a LOW logical value, is detected regardless of the logical level of the key. Thus, when a bit of the plaintext message is a LOW logical value the output (e.g., the total read current value 1050) is a LOW logical value regardless of whether the corresponding bit of the key is at a LOW logical level or a HIGH logical level, as shown in Truth Table 5 below:

Truth Table 5

| Plaintext | | Output |
|---|---|---|
| Message | Key | (Ciphertext) |
| 0 | 0 | 0 |
| 0 | 1 | 0 |

Thus, as seen above, based on current threshold detection (e.g., the total read current value 1050), the output in the first row of Truth Table 5 above shows a correct XOR operation between the plaintext message and the key (e.g., the XOR operation matches the first row of Truth Table 1). However, the output in the second row of Truth Table 5 above does not show a correct result of an XOR operation. Thus, a modified XOR operation is needed when the plaintext message is at a LOW logical level to obtain the correct ciphertext (e.g., the output). The modified XOR operation may be performed using the following logical operation:
When Plaintext Message=0; Output=WRITE (Key)

In other words, when a particular bit of the plaintext message is “0,” the output (e.g., the ciphertext) in the Truth Table 5 may be obtained by writing the bit of the key as the ciphertext. Thus, the modified XOR operation when the plaintext bit is “0” may be implemented as follows:

Truth Table 6

| Plaintext | | Output |
|---|---|---|
| Message | Key | (Ciphertext) |
| 0 | 0 | 0 |
| 0 | 1 | 1 |

As seen from Truth Table 6 above, the output is the same as the key.

When a voltage pulse 1055 is applied to read a HIGH logical value of a bit of the plaintext message 1030, a total read current value 1060, which is a HIGH logical value, is detected regardless of the logical level of the key. Thus, when a bit of the plaintext message 1030 is at a HIGH logical level, the output (e.g., the total read current value 1060) is a HIGH logical level regardless of whether the corresponding bit of the key is at a LOW logical level or a HIGH logical level, as shown in Truth Table 7 below:

Truth Table 7

| Plaintext | | Output |
|---|---|---|
| Message | Key | (Ciphertext) |
| 1 | 0 | 1 |
| 1 | 1 | 1 |

Thus, as seen above, based on current threshold detection (e.g., the total read current value 1060), the output in the first row of Truth Table 7 above shows a correct XOR operation between the plaintext message and the key. However, the output in the second row of Truth Table 7 above does not show a correct result of an XOR operation. Thus, a modified XOR operation is needed when the plaintext message is at a HIGH logical to obtain the correct ciphertext (e.g., the output) based on the logical levels of the corresponding bit of the key. The modified XOR operation may be performed using the following logical operation:
When Plaintext Message=1; Output=WRITE (NOT (Key))

Therefore, when a particular bit of the plaintext message is at a HIGH logical level, the output (e.g., the ciphertext) in the Truth Table 7 may be corrected by writing an inverse of the bit of the key as the ciphertext. Thus, the modified XOR operation when the plaintext bit is at a HIGH logical level may be implemented as follows:

Truth Table 8

| Plaintext | | Output |
|---|---|---|
| Message | Key | (Ciphertext) |
| 1 | 0 | 1 |
| 1 | 1 | 0 |

As seen from Truth Table 8 above, the output is the inverse of the key.

Returning back to FIG. 10A, to perform the modified XOR operation, the encryption block 1000 determines, in logic block 1065, whether a bit of the plaintext message is at a LOW logical level or a HIGH logical level. If the bit of the plaintext message is at a LOW logical level, then based upon Truth Table 6 above, the corresponding bit of the key output 1020 is stored as a corresponding bit of the ciphertext. Thus, a write pulse (e.g., a current pulse) 1070 may be applied to a memory cell 1075 to store the key output 1020 in the memory cell as a ciphertext output 1080. On the other hand, if the encryption block 1000 determines in the logic block 1065 that a particular bit of the plaintext message 1030 is at a HIGH logical level, then based upon Truth Table 8 above, an inverse of the key output 1020 may be stored as the corresponding ciphertext bit. Thus, a write pulse 1085 may be applied to a memory cell 1090 to store an inverse of the key output 1020 as ciphertext output 1095.

Therefore, by using the current-voltage characteristic 1005 and current threshold detection, a modified XOR operation may be applied to perform encryption. By using current threshold detection to perform modified XOR operations, the need for using any CMOS transistor or pass through transistor logic in the encryption block 1000 (or the decryption block 900) may be avoided, thereby simplifying XOR operations, increasing the speed of XOR operations, and allowing XOR operations to be performed within the memory module itself.

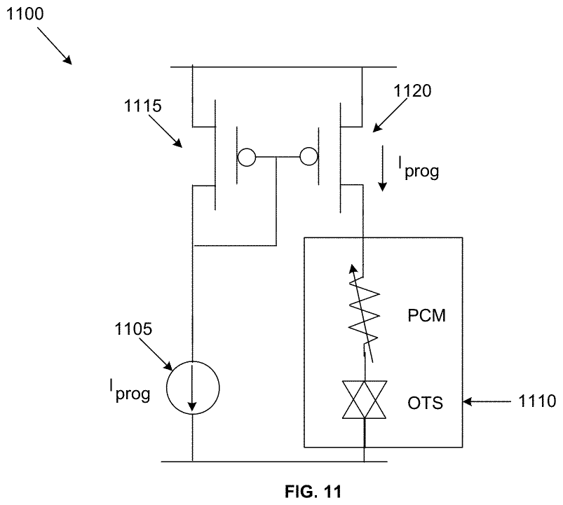

Turning now to FIG. 11, a write circuit 1100 is shown, in accordance with some embodiments of the present disclosure. The write circuit 1100 is a metal-oxide-semiconductor field effect transistor (“MOSFET”) device, which may be used by the decryption block 900 and the encryption block 1000 to write or program bits to a memory cell. The program operation by the write circuit 1100 may be performed by applying a current pulse (Iprog) 1105 to a memory cell 1110 and using a current mirror configuration. A p-mos transistor 1115 may be configured in in a diode configuration with low input impedance and a p-mos transistor 1120 may be configured in a diode configuration with a high output impedance. The current pulse 1105 may be generated by an ideal current source that may be programmed with different values (e.g., different values used to write a HIGH logical level, a LOW logical level, an optimal write pulse discussed above, etc.). The current mirror configuration of the write circuit 1100 is, thus, a current-controlled current source used to deliver the current from via the current pulse 1105 to different parts of a chip regardless of the loading (due to the high output impedance of the p-mos transistor 1120). In other embodiments, other configurations of the write circuit 110 may be implemented.

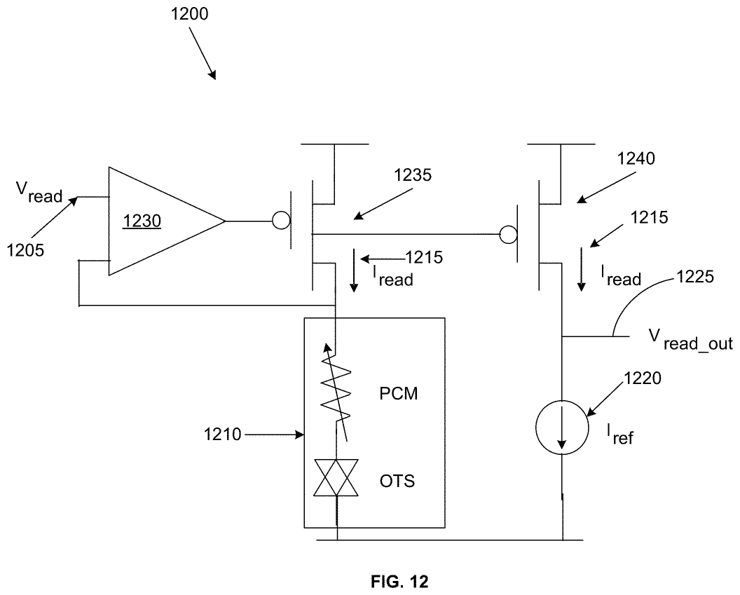

Turning to FIG. 12, a read circuit 1200 is shown, in accordance with some embodiments of the present disclosure. The read circuit 1200 may be used by the decryption block 900 and the encryption block 1000 to read bits from a memory cell. The read operation may be performed by applying a voltage pulse (Vread) 1205 to a memory cell 1210 from which a bit has to be read, and comparing a read current (Tread) 1215 with a reference current (Iref) 1220 to obtain an output voltage value (Vread_out) 1225. Specifically, the voltage pulse 1205 is applied to the memory cell 1210 via a voltage buffer configuration 1230 independent of the impedance of the memory cell. The read current 1215 going through the memory cell 1210 is mirrored into p-mos transistors 1235 and 1240, both of which may be biased in the same way to drive the same read current (e.g., the read current 1215). The voltage value 1225 is a HIGH logical value if the read current 1215 is greater than the reference current 1220 (e.g., if Iread>Iref). Otherwise, the voltage value 1225 is a LOW logical value. In other embodiments, other configurations of the read circuit 1200 may be used.

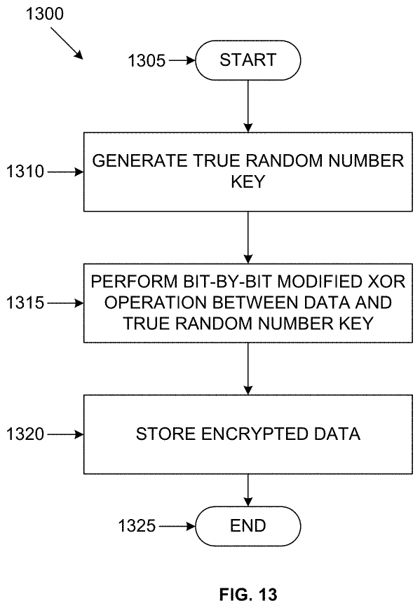

Referring to FIG. 13, an example flowchart outlining operations of a process 1300 for encrypting data using a perfect secrecy implementation is shown, in accordance with some embodiments of the present disclosure. The process 1300 may include additional or other operations depending upon the particular embodiment. The process 1300 may be implemented by the peripheral circuit (e.g., the peripheral circuit 330) of an associated memory module (e.g., the memory module 310). The process 1300 is discussed in conjunction with FIGS. 3 and 10A-10B. The process 1300 starts at operation 1305 when the peripheral circuit 330 receives a request to write data to the memory module 310. The peripheral circuit 330 may receive the request from a host device (e.g., the host device 105) via the memory controller 305. Specifically, the host device may send a write request to write the data to the memory controller 305. The host device may (or may not) identify the logical block address of the memory module 310 where the data is to be written. The host device may also identify whether the data is to be encrypted using perfect secrecy or semantic secrecy. In some embodiments, the memory module 310 may be configured for either a perfect secrecy implementation or a semantic secrecy implementation. In other embodiments, the memory module 310 may be configured for both perfect secrecy and semantic secrecy implementations. In such cases, certain partitions may be created and/or address ranges in the memory module 310 may be identified where a perfect secrecy implementation is applied and other partitions may be created and/or other address ranges in the memory module may be identified where the semantic secrecy implementation is applied.

Thus, in those embodiments in which the memory module 310 only applies a perfect secrecy implementation, the peripheral circuit 330 may assume that the data is to be encrypted using a perfect secrecy implementation. Similarly, in those embodiments, in which the memory module 310 is configured for only semantic secrecy implementation, the peripheral circuit 330 may assume that the data is to be encrypted using the semantic secrecy implementation. In those embodiments in which the memory module 310 is configured for both perfect and semantic secrecy implementations, the peripheral circuit 330 may determine which of the perfect or secrecy implementations to apply in encrypting the data in a variety of ways. In some embodiments, the peripheral circuit 330 may receive an instruction from the memory controller 305 to apply either a perfect secrecy or a semantic secrecy implementation. The memory controller 305 may determine which of the perfect secrecy or secret secrecy implementation to apply based on instructions received from the host device, the logical block address where the data is to be stored, etc. In some embodiments, the peripheral circuit 330 may identify which of the perfect or semantic secrecy implementations to use based upon the logical block address/physical block address of the memory module 310 where the data is to be stored. For example, the memory controller 305 and/or the peripheral circuit 330 may convert the logical block address of the memory module 310 where the data is to be stored into a physical block address, and determine if that physical block address is configured (e.g., reserved) for a perfect secrecy or a semantic secrecy implementation.

Thus, upon receiving a request to write data to a memory address of the memory module 310, and determining that the data is to be encrypted using a perfect secrecy implementation, the peripheral circuit 330 generates a key for the data at operation 1310. As discussed above, the key that is used in a perfect secrecy implementation is a true random number key. A new key or a new true random number is generated each time a piece of data is to be encrypted. The peripheral circuit 330 may generate the true random number key automatically when a piece of data is to be encrypted using the perfect secrecy implementation. The true random number key may be generated by leveraging the random switching properties of the memory module. Thus, the peripheral circuit 330, and particularly, the key generator block of the peripheral circuit, may apply an optimal write pulse (e.g., a current pulse) to induce a random switching of the bits in the memory cells of the key space where the key is to be stored. The randomly switched bits form the true random number key.

At operation 1315, the peripheral circuit 330 reads the true random number key from the key space bit-by-bit and performs a bit-by-bit modified XOR between the bits of the true random number key and the bits of the data to be written in the memory module 310. The data constitutes the plaintext message. The modified XOR operation is performed as discussed above with respect to FIGS. 10A and 10B. Thus, the peripheral circuit 330, and particularly, the encryption block (e.g., the encryption block 1000) of the peripheral circuit determines the bits of the ciphertext based upon the logical level of the bits of the plaintext message. Thus, if a bit of the plaintext message is at a LOW logical level (e.g., “0”), then the logical level of the corresponding bit of the true random number key is written as the logical level of the corresponding ciphertext bit. For example, if the true random number key bit is “0,” the corresponding ciphertext bit is a “0” and if the true random number key bit is “1,” the corresponding ciphertext bit is “1.”

Similarly, if a bit of the plaintext message is at a HIGH logical level, an inverse of the logical level of the corresponding bit of the true random number key is written as the logical level of the corresponding ciphertext bit. Thus, if the true random number key bit is “0,” the corresponding ciphertext bit is “1,” and if the true random number key bit is “1,” the corresponding ciphertext bit is “0.” The modified XOR operation of the operation 1315 is repeated for each bit of the plaintext message and the corresponding bit of the true random number key to obtain the ciphertext. At operation 1320, the peripheral circuit 330 stores the ciphertext in the ciphertext space. The process 1300 ends at operation 1325.

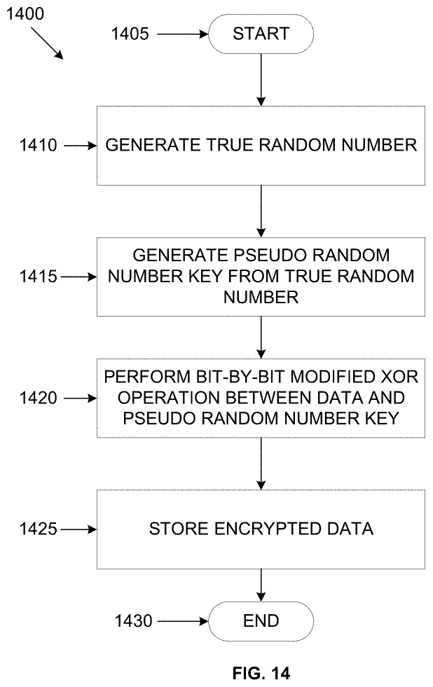

Referring now to FIG. 14, an example flowchart outlining operations of a process 1400 for encrypting data using a semantic secrecy implementation is shown, in accordance with some embodiments of the present disclosure. The process 1400 may include additional or other operations depending upon the particular embodiment. The process 1400 may be implemented by the peripheral circuit (e.g., the peripheral circuit 430) of an associated memory module (e.g., the memory module 410). The process 1400 is discussed in conjunction with FIGS. 4 and 10A-10B. The process 1400 starts at operation 1405 when the peripheral circuit 430 receives a request to write data to the memory module 410 in the manner discussed above. The peripheral circuit 430 may also identify that the data is to be encrypted using a semantic secrecy implementation. The peripheral circuit 430 may make the determination in the manner discussed above. Further, a pseudo random number key is used in a semantic secrecy implementation. As also discussed above, the pseudo random number key is generated from a true random number.

Thus, at operation 1410, the peripheral circuit 430 generates a true random number as discussed above with respect to the operation 1310. One true random number may be used to generate multiple pseudo random number keys. The peripheral circuit 430 may know how many pseudo random number keys may be generated from one true random number and the operation 1410 may only be performed when a new true random number is needed. The peripheral circuit 430 may keep track of the number of pseudo random keys that have been generated from one true random number. In some embodiments, a different true random number may be used for certain portions of the memory module 410. For example, in some embodiments, one true random number may be used for one tile of the memory module 410 and another true random number may be used for another tile. Thus, the peripheral circuit 430 may keep track of the number of pseudo random number keys that have been generated from the true random number for each of those tiles.

At operation 1415, the peripheral circuit 430 generates a new pseudo random number key for the data to be written. The pseudo random number key may be generated automatically by the peripheral circuit 430 when the request to write the data is received. The peripheral circuit 430 may generate the pseudo random number as discussed above from the true random number, the counter indicative of how many times a particular bit has been written, and an address (either logical block address or physical block address) of the memory module 410 where the data is to be written. The pseudo random number key may be stored within the key space of the memory module 410.

To encrypt the data, at operation 1420, the peripheral circuit 430 reads the pseudo random number key from the key space bit-by-bit and performs a bit-by-bit modified XOR between the bits of the pseudo random number key and the bits of the data to be written in the memory module 410. The data constitutes the plaintext message. The modified XOR operation is performed as discussed above with respect to FIGS. 10A and 10B, and the operation 1315. At operation 1425, the peripheral circuit 430 stores the ciphertext in the ciphertext space of the memory module 410. The process 1400 ends at operation 1430.

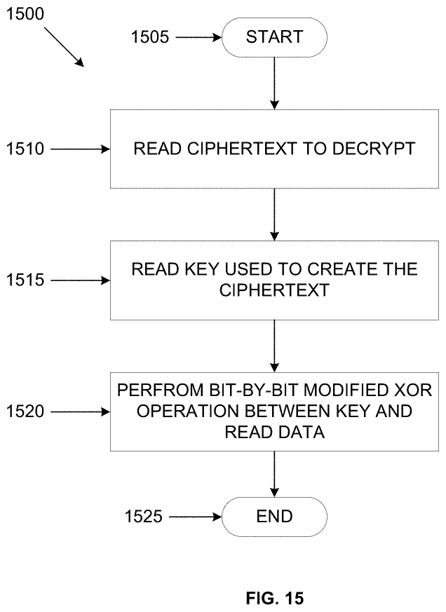

Referring to FIG. 15, an example flowchart outlining operations of a process 1500 for decrypting data using either a semantic secrecy implementation or a perfect secrecy implementation is shown, in accordance with some embodiments of the present disclosure. Thus, the decryption process is the same for both perfect secrecy and semantic secrecy implementations. The process 1500 may include additional or other operations depending upon the particular embodiment. The process 1500 may be implemented by the peripheral circuit (e.g., the peripheral circuit 330, the peripheral circuit 430) of an associated memory module (e.g., the memory module 310, the memory module 410). The process 1400 is discussed in conjunction with FIGS. 3, 4, and 9A-9B.

The process 1500 starts at operation 1505 when the peripheral circuit 330 or the peripheral circuit 430 receives a request to read data from the memory module 310 or the memory module 410, respectively, that was previously encrypted. Upon receiving the request, the peripheral circuit receiving the request reads the ciphertext bit-by-bit. At operation 1515, the peripheral circuit receiving the request also reads the key that was used to create the ciphertext being read at the operation 1510. The key is also read bit-by-bit. In some embodiments, the operations 1510 and 1515 may be performed simultaneously or substantially simultaneously. In other embodiments, the operation 1515 may be performed before the operation 1510. Upon reading a bit of the key and a bit of the ciphertext, the peripheral circuit performing the decryption operation performs a bit-by-bit modified XOR operation at operation 1520, as discussed above with respect to FIGS. 9A and 9B. The decrypted data is returned to the memory controller and the process 1500 ends at operation 1525.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A non-transitory computer-readable media having computer-readable instructions stored thereon that when executed by a processor associated with a memory module cause the processor to:
receive a request to store data in the memory module;
generate a true random number key by applying an optimal write pulse to a first plurality of memory cells of the memory module; and
perform a first modified XOR operation between the data and the true random number key to obtain a ciphertext,
wherein in the first modified XOR operation, a bit of the ciphertext has a same logical value as a corresponding bit of the true random number key when a corresponding bit of the data is at a low logical value; and
wherein in the first modified XOR operation, the bit of the ciphertext is inverse of the logical value of the corresponding bit of the true random number key when the corresponding bit of the data is at a high logical value.

2. The non-transitory computer-readable media of claim 1, wherein the first plurality of memory cells form part of a key space of the memory module.

3. The non-transitory computer-readable media of claim 2, further comprising instructions to store the ciphertext in a second plurality of memory cells that form a ciphertext space of the memory module.

4. The non-transitory computer-readable media of claim 3, wherein the key space and the ciphertext space are about equal in size.

5. The non-transitory computer-readable media of claim 3, wherein the key space forms about a first half of a storage space of the memory module and the ciphertext space forms about a second half of the storage space of the memory module.

6. The non-transitory computer-readable media of claim 1, further comprising instructions to:
receive another request to read the ciphertext from the memory module; and
perform a second modified XOR operation between the ciphertext and the true random number key to obtain the data.

7. The non-transitory computer-readable media of claim 6, wherein in the second modified XOR operation, for the high logical value of the bit of the ciphertext, the corresponding bit of the data is also at the high logical value when the corresponding bit of the true random number key is at the low logical value.

8. The non-transitory computer-readable media of claim 6, wherein in the second modified operation, for the low logical value of the bit of the ciphertext, the corresponding bit of the data is also at the low logical value when the corresponding bit of the true random number key is at the low logical value.

9. The non-transitory computer-readable media of claim 6, wherein in the second modified operation, for the low logical value of the bit of the ciphertext, the corresponding bit of the data is at the high logical value when the corresponding bit of the true random number key is at the high logical value.

10. The non-transitory computer-readable media of claim 6, wherein in the second modified operation, for the high logical value of the bit of the ciphertext, the corresponding bit of the data is at the low logical value when the corresponding bit of the true random number key is at the high logical value.

11. A non-transitory computer-readable media having computer-readable instructions stored thereon that when executed by a processor associated with a memory module cause the processor to:
receive a request to store data in the memory module;
generate a true random number by applying an optimal write pulse to a first plurality of memory cells of the memory module;
generate a pseudo random number key from the true random number;
perform a first modified XOR operation between the data and the pseudo random number key to obtain a ciphertext,
wherein in the first modified XOR operation, a bit of the ciphertext has a same logical value as a corresponding bit of the pseudo random number key when a corresponding bit of the data is at a low logical value; and
wherein in the first modified XOR operation, the bit of the ciphertext is inverse of the logical value of the corresponding bit of the pseudo random number key when the corresponding bit of the data is at a high logical value.

12. The non-transitory computer-readable media of claim 11, wherein a counter and an address of the memory module where the data is to be stored form a seed along with the true random number to generate the pseudo random number key.

13. The non-transitory computer-readable media of claim 11, wherein a plurality of pseudo random number keys are generated from one instance of the true random number.

14. The non-transitory computer-readable media of claim 11, wherein:
the first plurality of memory cells form part of a key space of the memory module;
the ciphertext is stored in a second plurality of memory cells that form a ciphertext space of the memory module; and
the key space is smaller in size than the ciphertext space.

15. The non-transitory computer-readable media of claim 11, further comprising instructions to:
receive another request to read the ciphertext from the memory module; and
perform a second modified XOR operation between the ciphertext and the pseudo random number key to obtain the data,
wherein in the second modified XOR operation, the logical value of the bit of the ciphertext forms the logical value of the corresponding bit of the data when the corresponding bit of the pseudo random number key is at the low logical value; and
wherein in the second modified XOR operation the inverse of the logical value of the bit of the ciphertext forms the logical value of the corresponding bit of the data when the corresponding bit of the pseudo random number key is at the high logical value.

16. A memory device comprising:
a memory controller; and
a memory module comprising a key space and a ciphertext space,
wherein the memory module encrypts a data with a key that is stored in the key space to obtain a ciphertext that is stored in the ciphertext space;
wherein the memory module decrypts the ciphertext with the key to obtain the data;
wherein the memory module performs a first modified XOR operation to encrypt the data and a second modified XOR operation to decrypt the ciphertext;
wherein in the first modified XOR operation, a bit of the ciphertext has a same logical value as a corresponding bit of the key when a corresponding bit of the data is at a low logical value and the bit of the ciphertext is inverse of the logical value of the corresponding bit of the key when the corresponding bit of the data is at a high logical value; and
wherein in the second modified XOR operation, the logical value of the bit of the ciphertext forms the logical value of the corresponding bit of the data when the corresponding bit of the key is at the low logical value and the inverse of the logical value of the bit of the ciphertext forms the logical value of the corresponding bit of the data when the corresponding bit of the key is at the high logical value.

17. The memory device of claim 16, wherein the key space is of a substantially same size as the ciphertext space in a perfect secrecy implementation, and wherein the key space is of a lesser size than the ciphertext space in a semantic secrecy implementation.

18. The memory device of claim 16, wherein the key is a true random number key for a perfect secrecy implementation, and wherein the key is a pseudo random number key for a semantic secrecy implementation.

19. The memory device of claim 16, wherein the key is a true random number key, wherein the memory module generates the true random number key by applying an optimal write pulse to a plurality of memory cells of the key space where the key that is generated is to be stored, and wherein the optimal write pulse randomly switches a state of each of the plurality of memory cells to generate the true random number key.

20. The memory device of claim 16, wherein the key is a pseudo random number key, wherein the memory module generates the pseudo random number key from a true random number, a counter value, and am address of the memory module where the data is to be stored.
